(19) United States
(12) Patent Application Publication
(10) Pub. No.: US 2016/0367106 A1
(43) Pub. Date: Dec. 22, 2016

(54) DISHWASHER APPLIANCE AND A METHOD FOR FORMING A UNITARY SUMP

(71) Applicant: General Electric Company, Schenectady, NY (US)

(72) Inventors: Ramasamy Thiyagarajan, Louisville, KY (US); Adam Christopher Hofmann, Louisville, KY (US)

(21) Appl. No.: 14/744,113

(22) Filed: Jun. 19, 2015

(51) Int. Cl. A47L 15/42; G06F 17/50; G05B 15/02

(52) U.S. Cl. CPC A47L 15/4221; A47L 15/4202; G05B 15/02; G06F 17/50

(57) ABSTRACT

A dishwasher appliance with a unitary sump, wherein the sump is integrally formed of a continuous piece of material such that a sump portion and a first filter portion of the unitary sump are integrally formed of the continuous piece of material, is provided. A dishwasher appliance with a unitary sump, wherein the sump is integrally formed of a continuous piece of material such that a sump portion and a diverter housing portion of the unitary sump are integrally formed of the continuous piece of material, also is provided. Further, a related method for forming a unitary sump for a dishwasher appliance is provided.

### FIELD OF THE INVENTION

The present subject matter relates generally to dishwasher appliances and sumps for dishwasher appliances.

### BACKGROUND OF THE INVENTION

Dishwasher appliances generally include a tub and spray assemblies. The spray assemblies direct sprays of wash fluid onto articles within the tub during operation of the dishwasher appliance, and the wash fluid sprayed from spray assemblies eventually flows to a sump typically positioned at a bottom portion of the tub. To supply wash fluid to the spray assemblies, dishwasher appliances generally include a pump, which may receive wash fluid from the sump to recirculate within the tub. To protect the pump and to prevent food and other undesirable particles from being sprayed onto the articles when the wash fluid is recirculated, one or more filters usually are positioned in the sump upstream of the pump to filter the particles from the wash fluid.

Further, the pump may not be configured to supply fluid to all of the spray-arm assemblies simultaneously, and conventional dishwasher appliances typically use a device, referred to as a diverter, to control the flow of fluid within the dishwasher appliance. For example, the diverter typically incorporates a diverter element within a diverter housing to selectively control which spray-arm assemblies receive fluid. The diverter typically is disposed in or near the sump of the dishwasher appliance.

Separately forming the sump and one or more filter elements and/or the sump and a diverter housing poses certain challenges. For example, the joints between the sump and a filter element and/or the sump and a diverter housing can leak, and fluid from such leaks can, for example, damage components of the dishwasher appliance and/or the area in which the dishwasher is installed, such as, e.g., kitchen cabinets that may surround the dishwasher and/or the floor beneath the dishwasher. Additional components to prevent leaks, such as, e.g., seals, gaskets, or the like, and/or manufacturing techniques such an overmolding process to depose a polymer or other suitable material onto, e.g., the diverter housing in the area where the housing is joined to the sump, can increase the time and expense of the dishwasher appliance and leaks can still occur in spite of such precautions.

Accordingly, a dishwasher appliance with features for reducing leaks between a filter element and a sump would be useful. In addition, a dishwasher appliance with features for reducing leaks between a diverter housing and a sump would be beneficial.

### BRIEF DESCRIPTION OF THE INVENTION

The present subject matter provides a dishwasher appliance with a unitary sump, wherein the sump is integrally formed of a continuous piece of material such that a sump portion and a first filter portion of the unitary sump are integrally formed of the continuous piece of material. The present subject matter also provides a dishwasher appliance with a unitary sump, wherein the sump is integrally formed of a continuous piece of material such that a sump portion and a diverter housing portion of the unitary sump are integrally formed of the continuous piece of material. A related method for forming a unitary sump for a dishwasher appliance also is provided. Additional aspects and advantages of the invention will be set forth in part in the following description, or may be apparent from the description, or may be learned through practice of the invention.

In a first exemplary embodiment, a dishwasher appliance is provided. The dishwasher appliance includes a tub defining a wash chamber. A sump including a sump portion and a first filter portion is positioned in a bottom portion of the tub. The sump is integrally formed of a continuous piece of material such that the sump portion and the first filter portion are integrally formed of the continuous piece of material. The dishwasher appliance also includes a fluid circulation assembly for circulating fluid within the tub, the fluid circulation assembly including at least two spray assemblies for directing fluid onto articles placed in the wash chamber. The dishwasher appliance further includes a pump in fluid communication with the fluid circulation assembly, the pump having a pump inlet. The first filter portion of the sump is upstream of and in fluid communication with the pump inlet such that the pump inlet receives fluid filtered through the first filter element.

In a second exemplary embodiment, a dishwasher appliance is provided. The dishwasher appliance includes a tub defining a wash chamber and a fluid circulation assembly for circulating fluid within the tub, the fluid circulation assembly including at least two spray assemblies for directing fluid onto articles placed in the wash chamber. The dishwasher appliance also includes a pump in fluid communication with the fluid circulation assembly, the pump having a pump outlet. The dishwasher appliance further includes a sump positioned in a bottom portion of the tub, the sump including a sump portion and a diverter for selectively diverting fluid flow from the pump to the spray assemblies. The diverter comprises a diverter housing defining an inlet and at least two outlet ports, and a diverter element movable within the diverter housing. The diverter element is configured to divert fluid from the inlet to one of the at least two outlet ports. The sump portion and the diverter housing are formed of a continuous piece of material such that the sump is a single unitary component.

In a third exemplary embodiment, a method for forming a unitary sump for a dishwasher appliance is provided. The method includes establishing three-dimensional information of the unitary sump; converting the three-dimensional information of the unitary sump from the established three-dimensional information into a plurality of slices, each slice of the plurality of slices defining a respective cross-sectional layer of the unitary sump; and successively forming each cross-sectional layer of the unitary sump with an additive process. After each cross-sectional layer is successively formed, the unitary sump is formed such that the unitary sump includes a diverter housing portion integrally formed with a sump portion of a continuous piece of material, the diverter housing portion configured to receive fluid flow from a pump to be selectively diverted to a fluid circulation assembly by a diverter element positioned within the diverter housing portion.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front elevation view of a dishwasher appliance according to an exemplary embodiment of the present subject matter.

FIG. 2 provides a side section view of the exemplary dishwasher appliance of FIG. 1.

FIG. 3 provides a schematic cross-section view of a unitary sump of a dishwasher appliance according to an exemplary embodiment of the present subject matter.

FIG. 4 provides a schematic cross-section view of a unitary sump of a dishwasher appliance according to another exemplary embodiment of the present subject matter.

FIG. 5 provides a schematic cross-section view of a unitary sump of a dishwasher appliance according to another exemplary embodiment of the present subject matter.

FIG. 6 provides a schematic cross-section view of a unitary sump of a dishwasher appliance according to another exemplary embodiment of the present subject matter.

FIG. 6A provides a perspective view of a diverter housing portion of the unitary dishwasher sump of FIG. 6, with the sump portion removed for clarity, according to an exemplary embodiment of the present subject matter.

FIG. 7 illustrates a method for forming a unitary sump for a dishwasher appliance according to an exemplary embodiment of the present subject matter.

Use of the same reference numerals in different figures denotes the same or similar features.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

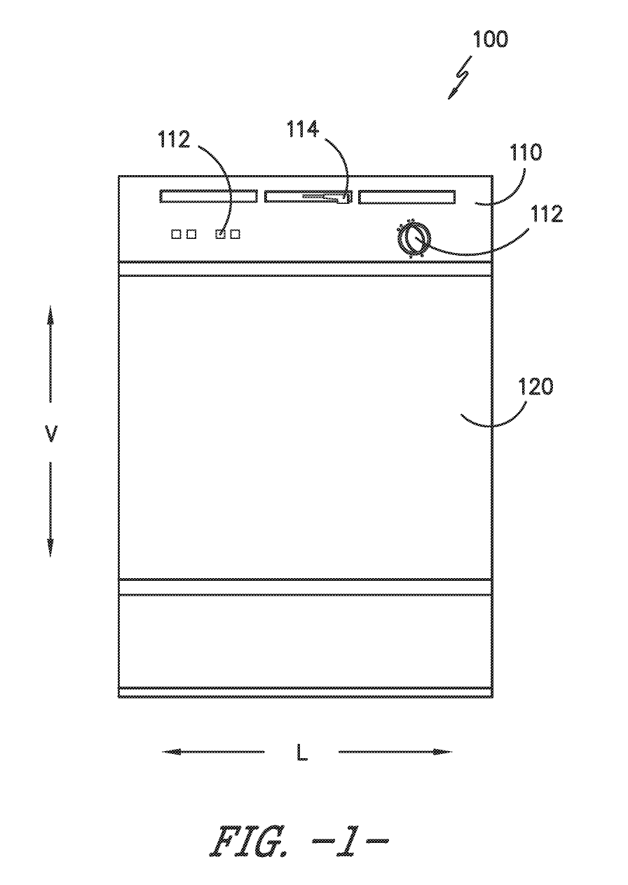

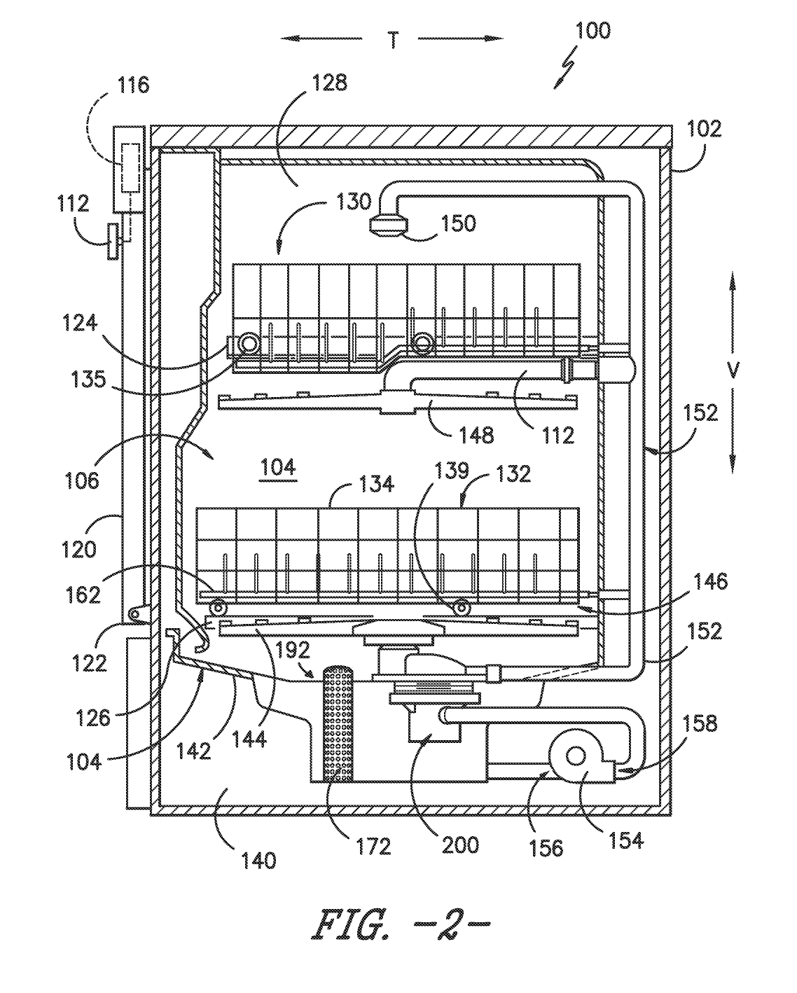

FIGS. 1 and 2 depict a dishwasher appliance 100 according to an exemplary embodiment of the present subject matter. Dishwasher appliance 100 defines a vertical direction V, a lateral direction L (FIG. 1) and a transverse direction T (FIG. 2). The vertical, lateral, and transverse directions V, L, and T are mutually perpendicular and form an orthogonal direction system.

Dishwasher appliance 100 includes a chassis or cabinet 102 having a tub 104. Tub 104 defines a wash chamber 106 and includes a front opening (not shown) and a door 120 hinged at its bottom 122 for movement between a normally closed vertical position (shown in FIGS. 1 and 2), wherein wash chamber 106 is sealed shut for washing operation, and a horizontal open position for loading and unloading of articles from dishwasher appliance 100. A latch 114 is used to lock and unlock door 120 for access to chamber 106.

Upper and lower guide rails 124, 126 are mounted on opposing tub sidewalls 128 to support and provide for movement of roller-equipped upper and lower rack assemblies 130, 132. Each of the upper and lower rack assemblies 130, 132 is fabricated into lattice structures including a plurality of elongated members 134 that extend in lateral (L), transverse (T), and/or vertical (V) directions (for clarity of illustration, not all elongated members making up assemblies 130, 132 are shown in FIG. 2). Each rack assembly 130, 132 is adapted for movement between an extended loading position (not shown) in which the rack is substantially positioned outside wash chamber 106, and a retracted position (shown in FIGS. 1 and 2) in which the rack is located inside wash chamber 106. This is facilitated by rollers 135 and 139, for example, mounted onto racks 130 and 132, respectively. A silverware basket (not shown) may be removably attached to the lower rack assembly 132 for placement of silverware, small utensils, and the like, that otherwise are too small to be accommodated by the upper and lower rack assemblies 130, 132.

Dishwasher appliance 100 also includes a lower spray-arm assembly 144 that is rotatably mounted within a lower region 146 of wash chamber 106 and above a tub sump portion 142 so as to rotate in relatively close proximity to lower rack assembly 132. A mid-level spray-arm assembly 148 is located in an upper region of wash chamber 106 and may be located in close proximity to upper rack assembly 130. Additionally, an upper spray assembly 150 may be located above the upper rack assembly 130.

Lower and mid-level spray-arm assemblies 144, 148 and upper spray assembly 150 are part of a fluid circulation assembly 152 for circulating fluid, such as water and wash fluid, within tub 104. Fluid circulation assembly 152 also includes a pump 154 positioned in a machinery compartment 140 located below sump 142 (i.e., the bottom wall) of tub 104, as generally recognized in the art. Through a pump inlet 156, pump 154 receives fluid filtered through one or more filter portions 170, 172 of sump 142, and through an outlet 158, pump 154 provides a flow of fluid to an inlet of a fluid diverter as more fully described below.

Each spray assembly 144, 148 includes an arrangement of discharge ports or orifices for directing washing liquid received from diverter 200 onto dishes or other articles located in upper and lower rack assemblies 130, 132, respectively. The arrangement of the discharge ports in spray-arm assemblies 144, 148 provides a rotational force by virtue of washing fluid flowing through the discharge ports. The resultant rotation of spray-arm assemblies 144, 148 and the operation of spray assembly 150 using fluid from diverter 200 provides coverage of dishes and other dishwasher contents with a washing spray. Other configurations of spray assemblies may be used as well.

Dishwasher appliance 100 is further equipped with a controller 116 to regulate operation of dishwasher appliance 100. Controller 116 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 116 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 116 may be positioned in a variety of locations throughout dishwasher appliance 100. In the illustrated embodiment, controller 116 may be located within a control panel area 110 of door 120 as shown. In such an embodiment, input/output (“I/O”) signals may be routed between the control system and various operational components of dishwasher appliance 100 along wiring harnesses that may be routed through bottom 122 of door 120. Typically, the controller 116 includes a user interface panel 112 through which a user may select various operational features and modes and monitor progress of the dishwasher appliance 100. In one embodiment, user interface panel 112 may represent a general purpose I/O (“GPIO”) device or functional block. In another embodiment, the user interface panel 112 may include input components, such as one or more of a variety of electrical, mechanical or electro-mechanical input devices including rotary dials, push buttons, and touch pads. User interface panel 112 may include a display component, such as a digital or analog display device designed to provide operational feedback to a user. User interface panel 112 may be in communication with controller 116 via one or more signal lines or shared communication busses.

It should be appreciated that the present subject matter is not limited to any particular style, model, or configuration of dishwasher appliance. Thus, the exemplary embodiment of dishwasher 100 depicted in FIGS. 1 and 2 is provided for illustrative purposes only. For example, different locations may be provided for a user interface 112, different configurations may be provided for upper and lower rack assemblies 130, 132 and/or lower and mid-level spray assemblies 144, 148, and other differences may be applied as well.

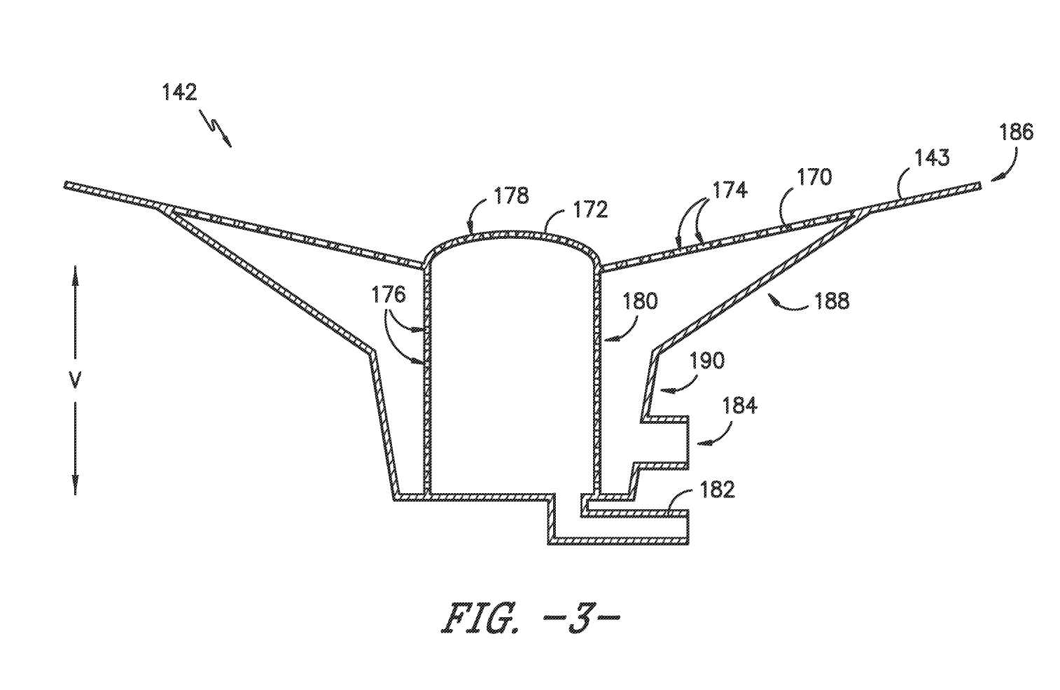

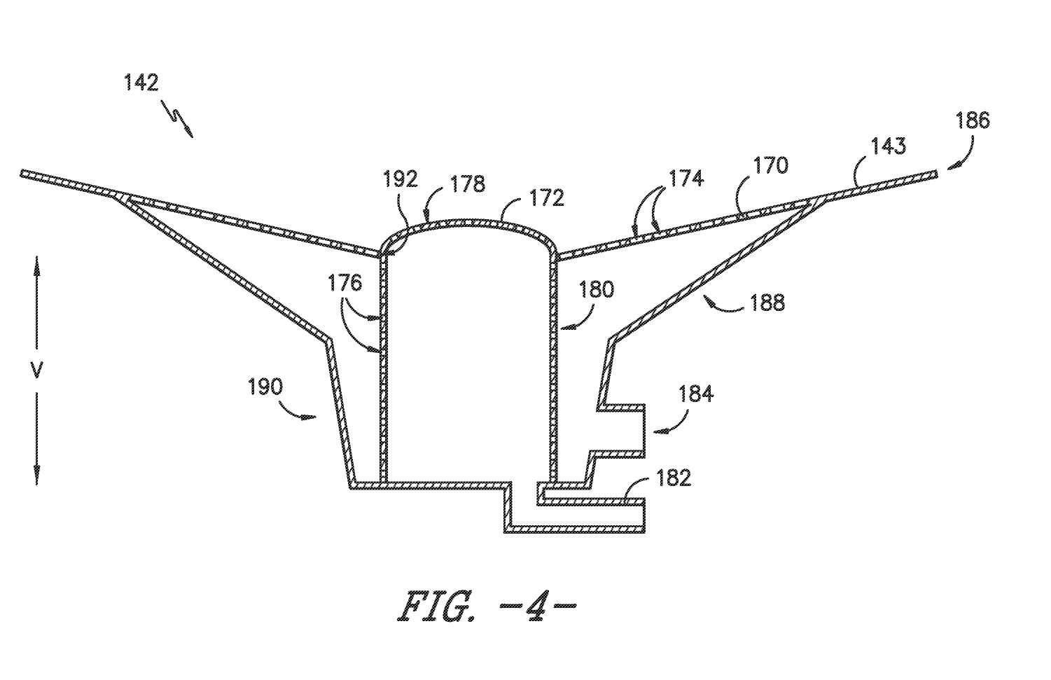

FIGS. 3 and 4 provide schematic cross-section views of a unitary sump 142 of dishwasher appliance 100 according to exemplary embodiments of the present subject matter. As shown, sump 142 may include a first filter portion 170 and a second filter portion 172. After being sprayed onto articles in the dishwashing appliance using one or more of spray assemblies 144, 148, and 150, fluid eventually flows to sump 142. In the illustrated embodiments, first filter portion 170 and second filter portion 172 comprise a plurality of openings 174, 176 for removing soiled particles from the fluid, which then may be recirculated through wash chamber 106 during operation of dishwasher 100. For example, after the fluid is filtered by passing through first filter portion 170 and second filter portion 172, the fluid flows to a pump conduit 184 that is in fluid communication with pump inlet 156. Thus, first and second filter portions 170, 172 are positioned upstream of pump inlet 156 such that fluid filtered through first and second filter portions 170, 172 is fed to inlet 156 of pump 154 for return to the wash chamber 106 by way of fluid recirculation assembly 152. Soil that is collected inside second filter portion 172 is directed to a sump drain line outlet 182 at a time in the wash cycle dictated by control 116.

First filter portion 170 may be configured to remove different sized particles from the fluid than second filter portion 172. For example, first filter portion 170 may be a coarse filter for removing relatively large particles and second filter portion 172 may be a fine filter for removing relatively small particles. That is, openings 174 of first filter portion 170 may be larger than openings 176 of second filter portion 172. In some embodiments, one or more filter portions may be positioned or formed downstream of second filter portion 172; these filter portions may be configured with smaller openings to remove smaller particles than are removed by second filter portion 172. Thus, smaller and smaller particles can be filtered from the fluid as the fluid flows through sump 142.

Second filter portion 172 may include a top 178 positioned above a body 180 along the vertical direction V. As illustrated in FIGS. 3 and 4, top 178 of second filter portion 172 may be generally rounded such that top 178 has a generally dome shape. Body 180 may be approximately cylindrical in shape. In some embodiments, top 178 and body 180 may be configured with openings 176 of the same size, i.e., to remove particles of about the same size. In other embodiments, top 178 and body 180 may be configured to remove different sized particles, e.g., top 178 may be configured to remove relatively large particles like first filter portion 170 and body 180 may be configured to remove relatively smaller particles. Other configurations of second filter portion 172 may be used as well.

Sump 142 may have an upper portion 186, intermediate portion 188, and a lower portion 190 defined along the vertical direction V. Upper portion 186 defines first filter portion 170, and second filter portion 172 may extend between upper portion 186 and lower portion 190, with top 178 of second filter portion 172 projecting above upper portion 186 as shown in FIGS. 3 and 4. Upper portion 186, intermediate portion 188, and lower portion 190 are generally funnel shaped, or comprise walls that are generally angled or sloped with respect to the vertical direction V, to direct fluid toward outlet 182, conduit 184, and/or other points of egress from sump 142. Sump 142 also may have other configurations.

In the exemplary embodiment of FIG. 3, sump 142 has a unitary construction, i.e., to form a unitary sump 142, first filter portion 170 and second filter portion 172 are integrally formed with a sump portion 143 from a continuous piece of material. As shown in FIG. 4, in other embodiments, first filter portion 170 is integrally formed with sump portion 143 from a continuous piece of material to form unitary sump 142. In such embodiments, second filter portion 172 may formed separately from unitary sump 142, and second filter portion 172 may be removable from unitary sump 142, e.g., for cleaning or other maintenance of second filter portion 172, outlet 182, conduit 184, or other areas accessible through an opening 192 in sump 142 for receiving second filter portion 172. In alternative embodiments, first filter portion 170 may be integrally formed with sump portion 143 to form unitary sump 142, without opening 192 or other provision for second filter portion 172. In still other embodiments, second filter portion 172 may be integrally formed with sump portion 143 to form unitary sump 142, with provision for receiving a separately formed first filter portion 170 or without provision for first filter portion 170. Other configurations of unitary sump 142 having one or more filter portions may be used as well.

The term “unitary” as used herein denotes that the associated component, such as sump 142 described herein, is made as a single piece during manufacturing, i.e., from a continuous piece of material. Thus, a unitary component has a monolithic construction and is different from a component that has been made from a plurality of component pieces that have been joined together to form a single component. More specifically, in the exemplary embodiment of FIG. 3, sump portion 143, first filter portion 170, and second filter portion 172 are constructed as a single unit or piece to form unitary sump 142, and in the exemplary embodiment of FIG. 4, sump portion 143 and first filter portion 170 are constructed as a single unit or piece to form unitary sump 142.

A plastic, polymer, metal, or other material may be an appropriate material for constructing the unitary sump 142. In some embodiments, a combination of materials may be integrally formed as a continuous piece to form the unitary sump 142. That is, although one portion of sump 142 may be formed of a different material than another portion, the portions are integrally formed such that the portions are formed of a single, continuous piece, i.e., the different materials are integral. For example, the continuous piece of material may comprise a first material and a second material. In the exemplary embodiment of FIG. 3, second filter portion 172 may be formed of the second material and first filter portion 170 and sump portion 143 may be formed of the first material. The first and second materials may form a continuous piece of material, e.g., by fusing together the first and second materials where they meet or by successively printing one layer of sump 142 on top of another, as further described below. In other embodiments, first filter portion 170 and/or second filter portion 172 may comprise pre-fabricated filters or screens and sump portion 143 is formed around first and second filter portions 170, 172 or around first filter portion 170 to produce unitary sump 142. For example, sump 142 may be formed using an additive process as described below and pre-fabricated filter portions 170, 172 may be inserted within sump portion 143 during the additive process to form unitary sump 142 having first filter portion 170 and/or second filter portion 172.

First and second filter portions 170, 172 may be any porous structure for filtering fluid flowing to sump 142. For example, first filter portion 170 may comprise a plurality of openings 174 that are generally round in shape; in other embodiments, openings 174 may be a generally hexagonal, octagonal, or other geometric shape. As another example, first and second filter portions 170, 172 may be mesh or other open cell structures, including multi-layer open cell structures such as, e.g., a honeycomb, lattice, or other type of multi-layer open cell structure. Using the exemplary method described below for forming a unitary dishwasher sump, first filter portion 170 and/or second filter portion 172 of unitary sump 142 may be constructed having any appropriate structure for filtering particles of food and other debris from the fluid, e.g., before the fluid flows to pump 154 for recirculation within dishwasher 100.

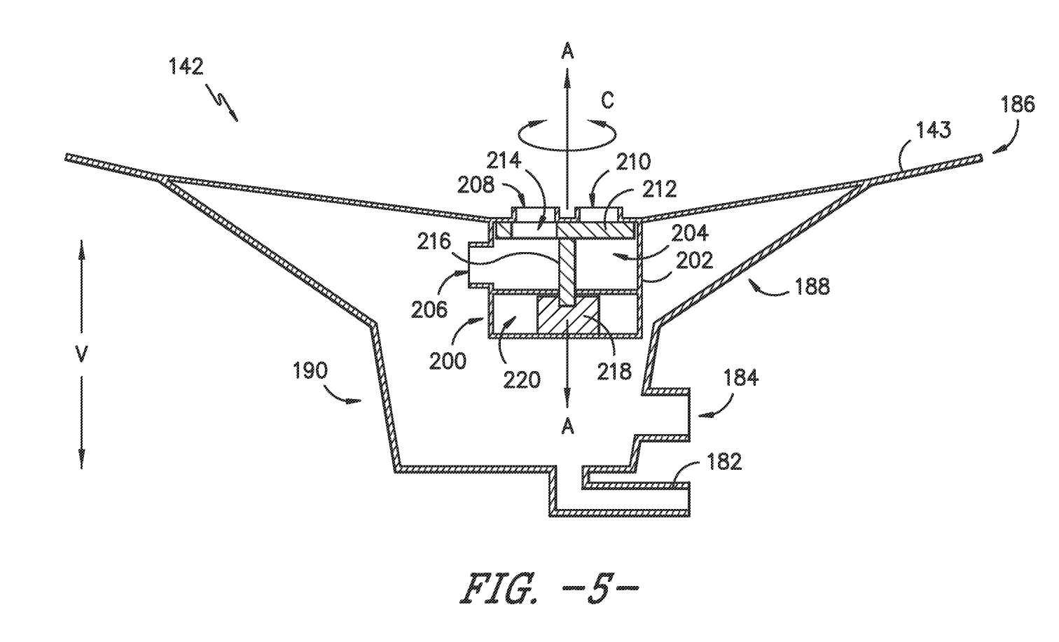

FIG. 5 provides a schematic cross-section view of a unitary dishwasher sump 142 having a fluid diverter 200 according to an exemplary embodiment of the present subject matter. Diverter 200 includes a diverter housing 202 defining a chamber 204. Diverter housing 202 further defines a diverter inlet 206 for receiving into chamber 204 a flow of fluid from pump 154 that is to be supplied to spray assemblies 144, 148, and/or 150 as well as other fluid-using components during cleaning operations. As described, pump 154 receives fluid filtered through, e.g., first filter portion 170 and/or second filter portion 172 and provides a fluid flow to diverter 200.

Diverter housing 202 defines a plurality of outlet ports; however, only a first outlet port 208 and a second outlet port 210 are shown in the cross-section view of the exemplary embodiment of FIG. 5. In alternative embodiments, diverter housing 202 may define two, three, four, or more outlet ports depending upon, e.g., the number of switchable ports desired for selectively placing pump 154 in fluid communication with different fluid-using elements of dishwasher 100. Diverter 200 includes a rotatable diverter element 212 having an aperture 214 that can be selectively switched between the plurality of outlet ports, including ports 208 and 210. For example, the outlet ports may be spaced apart along a circumferential direction C, and in an exemplary embodiment having four outlet ports, the outlet ports may be spaced apart along the circumferential direction C at angles of 90 degrees. Thus, the rotation of diverter element 212 by 90 degrees necessarily rotates aperture 214 so as to selectively provide fluid flow from one outlet port to the next outlet port along the direction of rotation.

In the exemplary embodiment of FIG. 5, diverter element 212 is a disk that can be rotated about an axis A-A (extending parallel to the vertical direction V in the exemplary embodiment) to selectively switch aperture 214 between the plurality of outlet ports to place an outlet port in fluid communication with chamber 204 of diverter housing 202. Thus, through the rotation of diverter element 212, diverter 200 can be used to selectively provide fluid flow from pump 154 through chamber 204 to any one of the outlet ports desired. By way of example, first outlet port 208 can be fluidly connected with upper spray assembly 150, second outlet port 210 can be fluidly connected with mid-level spray-arm assembly 148, and third and fourth outlet ports might be fluidly connected with lower spray-arm assembly 144. As such, the rotation of disk 212 in diverter 200 can be used to selectively place pump 154 in fluid communication with any one of the spray assemblies 144, 148, or 150 by way of the plurality of outlet ports. Other connection configurations may be used as well.

To rotate diverter element 212, diverter element 212 is in operative communication via a shaft 216 with a motor 218. As shown in FIG. 5, motor 218 may be positioned within a motor portion 220 of diverter housing 202, i.e., housing 202 may define an area for motor 218 that allows shaft 216 to extend between motor 218 and diverter element 212 and that protects motor 218 from the fluid flow within diverter housing 202. One or more seals, gaskets, or the like (not shown) may be used at the location where shaft 216 passes between motor portion 220 and chamber 204 to help prevent fluid intrusion into motor portion 220. Diverter housing 202 and diverter element 212 may have other configurations as well, including the power source for rotating diverter element 212. For example, in some embodiments, motor 218 may be positioned outside of diverter housing 202 and/or sump 142, and in other embodiments, diverter 200 may be powered by an alternative power source or may be a passive diverter, e.g., rotated by changes in pressure within the fluid system.

Diverter housing 202 is integrally formed with sump portion 143 from a continuous piece of material such that sump portion 143 and housing 202 have a unitary construction and form unitary sump 142. That is, sump portion 143 and diverter housing 202 are made together as a single unit or piece during manufacturing, i.e., from a continuous piece of material, to form unitary sump 142. A plastic, polymer, metal, or other material may be an appropriate material for constructing unitary sump 142. In some embodiments, unitary sump 142 may be formed from a combination of materials that are integrally formed as a continuous piece. That is, although one portion of sump 142 may be formed of a different material than another portion, the portions are integrally formed such that the portions are formed of a single, continuous piece, i.e., the different materials are integral.

In some embodiments, unitary sump 142 may include first filter portion 170, second filter portion 172, and diverter housing 202 integrally formed with sump portion 143 from a continuous piece of material. In other embodiments, unitary sump 142 may include first filter portion 170 and diverter housing 202 integrally formed with sump portion 143 from a continuous piece of material. In such embodiments, unitary sump 142 may be configured to receive second filter element 172, which may be removable from unitary sump 142. Other configurations of unitary sump 142, including diverter housing 202 and one or more filter portions as part of the unitary construction of sump 142, also may be used.

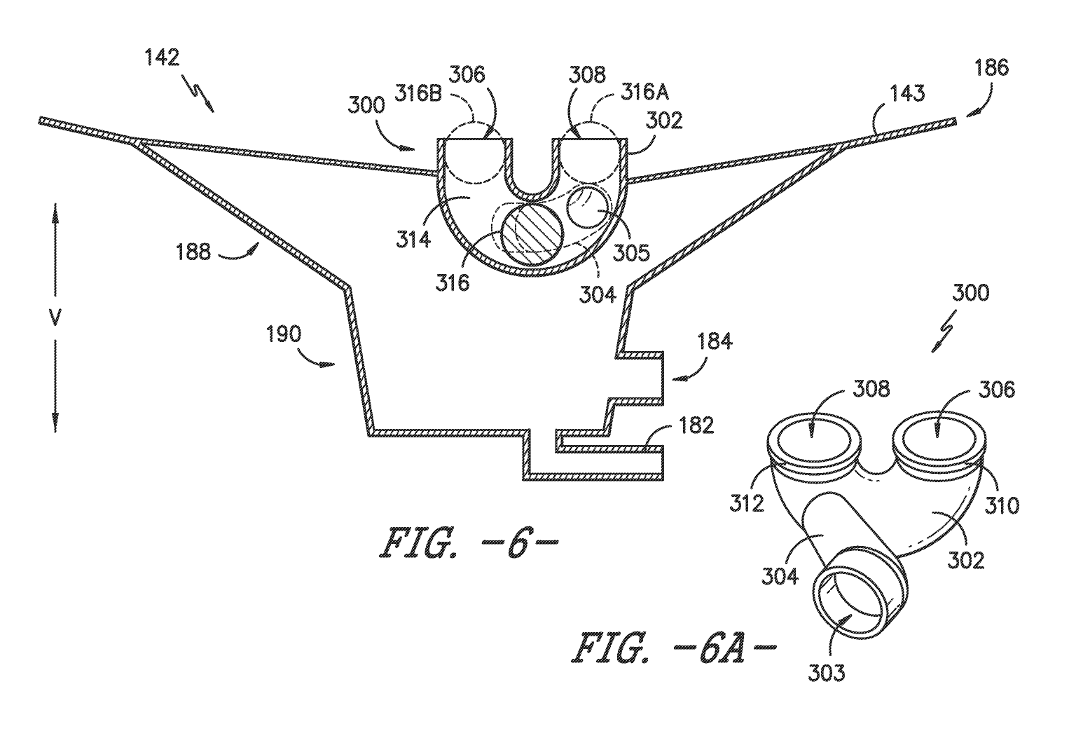

FIG. 6 provides a schematic cross-section view of a unitary dishwasher sump 142 having a passive fluid diverter 300 according to an exemplary embodiment of the present subject matter. FIG. 6A provides a perspective view of a diverter housing portion of the unitary dishwasher sump of FIG. 6, with sump portion 143 removed for clarity, according to an exemplary embodiment of the present subject matter. As shown, diverter 300 includes a diverter housing 302 defining a diverter inlet 304 for receiving a flow of fluid from pump 154 that is to be supplied to spray assemblies 144, 148, and/or 150 as well as other fluid-using components during cleaning operations. As described, pump 154 receives filtered fluid from, e.g., sump 142 and provides a fluid flow to diverter 300. Diverter inlet 304 may be an elongated inlet, extending from a first end 303 extending outwardly from diverter housing 302 for coupling diverter inlet 304 to pump 154 and a second end 305 terminating within housing 302. Thus, fluid received from pump 154 at first end 303 of diverter inlet 304 may be directed to second end 305 of inlet 304 and into diverter housing 302.

Diverter housing 302 defines a first outlet port 306 and a second outlet port 308 for diverting fluid from pump 154 received into diverter housing 302 to fluid-using components of dishwasher 100. In alternative embodiments, diverter housing 302 may define any other number of outlet ports, including three, four, or five or more outlet ports. Each outlet port may be configured to be in fluid communication (e.g., via a suitable conduit) with a different wash zone or spray assembly of the dishwasher appliance 100.

Further, each outlet port 306, 308 may include one or more mounting features for facilitating coupling of each outlet 306, 308 to its corresponding fluid distribution assembly component. For example, first outlet port 306 may be configured to be coupled directly to the lower spray-arm assembly 144 while second outlet port 308 may be configured to be coupled to fluid circulation assembly 152 in fluid communication with mid-level spray-arm and upper spray assemblies 148, 150. Thus, as shown in FIG. 6A, first outlet port 306 may include a suitable mounting feature(s) 310 that is configured to engage a corresponding mounting feature(s) (not shown) of the lower spray-arm assembly 144 for coupling such components together. Similarly, second outlet port 308 may include a suitable mounting feature(s) 312 that is configured to engage a corresponding mounting feature(s) (not shown) on fluid circulation assembly 152 for coupling such components together. For instance, mounting features 310, 312 may be one or more mounting tabs having an openings defined therein for receiving a corresponding projection (not shown) of lower spray-arm assembly 144 and fluid circulation assembly 152, respectively.

Diverter housing 302 may generally form a semi-circular shape. As such, a looped, semicircular flow path 314 may extend between first and second outlet ports 306, 308. As further shown in the illustrated embodiment of FIG. 6, diverter housing 302 may correspond to a passive ball valve that diverts the flow of fluid within housing 302 based on the position of a diverter element 316, such as a valve ball, within looped path 314. Specifically, diverter element 316 may be movable along looped path 314 between a first position, as shown by the dashed lines 316A, and a second position, as shown by the dashed lines 316B. In the first position 316A, diverter element 316 is positioned at second outlet port 308 so as to seal off second outlet port 308 such that the fluid directed into diverter housing 302 via diverter inlet 304 is diverted through first outlet port 306. In the second position 316B, diverter element 316 is positioned at first outlet port 306 so as to seal off first outlet port 306 such that the fluid directed into diverter housing 302 via diverter inlet 304 is diverted through second outlet port 308.

Diverter element 316 may be moved between the first and second positions due to fluid pressure exerted on diverter element 316 during operation of dishwasher appliance 100. For example, prior to the operation of dishwasher 100, diverter element 316 may be positioned at an intermediate location of looped path 314 between first and second outlet ports 306, 308, such as at the position of diverter element 316 shown in FIG. 6. Thereafter, when pump 154 begins to deliver fluid to diverter 300, the pressure of the fluid flowing into diverter housing 302 via diverter inlet 304 may force diverter element 316 upwards into its first position 316A such that it is sealed against the second outlet port 308. As such, all of the fluid flowing into diverter 300 may be initially diverted to first outlet port 306 for subsequent discharge from lower spray-arm assembly 144. Thereafter, when it is desired to divert the fluid from pump 154 to second outlet port 308, pump 154 may be temporarily cut off such that the pressure build-up of the fluid contained within fluid circulation assembly 152 forces diverter element 316 into its second position 316B such that it is sealed against the first outlet port 306. Pump 154 may then be turned on such that the pressure of the fluid flowing into diverter housing 302 via diverter inlet 304 maintains diverter element 316 sealed against first outlet port 306, thereby allowing the fluid flowing into diverter 300 to be diverted to second outlet port 308 for subsequent discharge from mid-level spray-arm and upper spray assemblies 148, 150.

Diverter housing 302 is integrally formed with sump portion 143 from a continuous piece of material such that sump portion 143 and housing 302 have a unitary construction and form unitary sump 142. That is, sump portion 143 and diverter housing 302 are made together as a single unit or piece during manufacturing, i.e., from a continuous piece of material, to form unitary sump 142. A plastic, polymer, metal, or other material may be an appropriate material for constructing unitary sump 142. In some embodiments, unitary sump 142 may be formed from a combination of materials that are integrally formed as a continuous piece. That is, although one portion of sump 142 may be formed of a different material than another portion, the portions are integrally formed such that the portions are formed of a single, continuous piece, i.e., the different materials are integral.

In some embodiments, unitary sump 142 may include first filter portion 170, second filter portion 172, and diverter housing 302 integrally formed with sump portion 143 from a continuous piece of material. In other embodiments, unitary sump 142 may include first filter portion 170 and diverter housing 302 integrally formed with sump portion 143 from a continuous piece of material. In such embodiments, unitary sump 142 may be configured to receive second filter element 172, which may be removable from unitary sump 142. Other configurations of unitary sump 142, including diverter housing 302 and one or more filter portions as part of the unitary construction of sump 142, also may be used.

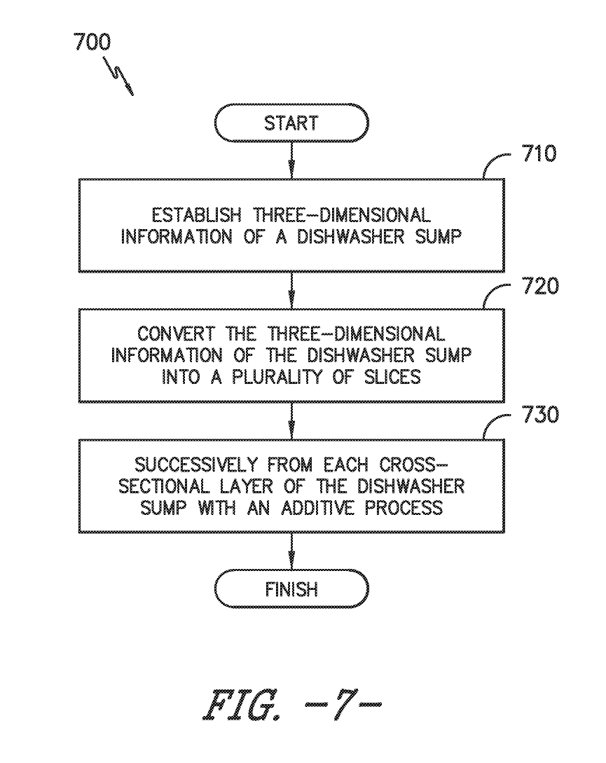

FIG. 7 illustrates a method 700 for forming a unitary sump for a dishwasher appliance according to an exemplary embodiment of the present subject matter. Method 700 may be used to form any suitable unitary sump. For example, method 700 may be used to form sump 142 as illustrated in FIGS. 3, 4, 5, and/or 6, as well as variations of the illustrated embodiments. Method 700 permits formation of various features of sump 142, as discussed in greater detail below. Method 700 includes fabricating sump 142 as a unitary sump, e.g., such that sump 142 is formed of a continuous piece of plastic, metal, or other suitable material. More particularly, method 700 includes manufacturing or forming sump 142 using an additive process, such as Fused Deposition Modeling (FDM), Selective Laser Sintering (SLS), Stereolithography (SLA), Digital Light Processing (DLP), Direct Metal Laser Sintering (DMLS), Laser Net Shape Manufacturing (LNSM), electron beam sintering and other known processes. An additive process fabricates plastic, metal, or other components using three-dimensional information, for example a three-dimensional computer model, of the component. The three-dimensional information is converted into a plurality of slices, each slice defining a cross section of the component for a predetermined height of the slice. The component is then “built-up” slice by slice, or layer by layer, until finished.

Accordingly, at step 710, three-dimensional information of sump 142 is determined. As an example, a model or prototype of sump 142 may be scanned to determine the three-dimensional information of sump 142 at step 710. As another example, a model of sump 142 may be constructed using a suitable CAD program to determine the three-dimensional information of sump 142 at step 710. At step 720, the three-dimensional information is converted into a plurality of slices that each defines a cross-sectional layer of sump 142. For example, the three-dimensional information from step 710 may be divided into equal sections or segments, e.g., along a central axis of sump 142 or any other suitable axis. Thus, the three-dimensional information from step 710 may be discretized at step 720, e.g., to provide planar cross-sectional layers of sump 142.

After step 720, sump 142 is fabricated using the additive process, or more specifically, each layer is successively formed at step 730, e.g., by fusing or polymerizing a plastic using laser energy or heat. The layers may have any suitable size. For example, each layer may have a size between about five ten-thousandths of an inch and about one thousandths of an inch. Sump 142 may be fabricated using any suitable additive manufacturing machine as step 730. For example, any suitable laser sintering machine, inkjet printer, or laserjet printer may be used at step 730.

Utilizing method 700, unitary sump 142 may have fewer components and/or joints than known sumps. Specifically, unitary sump 142 may require fewer components because sump 142 may be a single piece of continuous plastic, metal, or other material, e.g., rather than multiple pieces of plastic, metal, or other material joined or connected together. Also, sump 142 may be stronger when formed with method 700. Moreover, method 700 may form unitary sump 142 such that first and second filter portions 170, 172 are integrally formed with sump portion 143, which can reduce the number of joints and thereby reduce the number of leak points between sump portion 143 and first and second filter portions 170, 172. For example, without forming the sump as unitary sump 142, first filter portion 170 must be joined, connected, mounted, attached, or otherwise secured to sump portion 143, and fluid can leak at the points where first filter portion 170 is secured to sump portion 143. However, using method 700 to form unitary sump 142, the securing points are eliminated, which reduces the number of leak points in the sump.

Additionally or alternatively, method 700 may form unitary sump 142 such that diverter housing 202 or diverter housing 302 is integrally formed with sump portion 143, which can reduce the number of joints and, thus, leak points between sump portion 143 and diverter housing 202 or 302. As one example, without forming the sump as unitary sump 142, diverter housing 202 must be joined, connected, mounted, attached, or otherwise secured to sump portion 143, and fluid can leak at the points where diverter housing 202 is secured to sump portion 143. Typically, one or more seals or other components, or manufacturing techniques such as overmolding, are used to try to prevent leaks at the points where diverter housing 202 is secured to sump portion 143. Even taking these precautions, leaks may still occur and costs of dishwasher appliance 100 may be increased by the additional components, etc., used to try to prevent leaks, as well as the increased time to install such components, as such installation can be labor intensive. However, by using method 700 to form unitary sump 142, the securing points between sump portion 143 and diverter housing 202 are eliminated because they are integrally formed, which reduces the number of leak points in the sump without additional components.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A dishwasher appliance, comprising:
a tub defining a wash chamber;
a sump positioned in a bottom portion of the tub, the sump including a sump portion and a first filter portion, the sump integrally formed of a continuous piece of material such that the sump portion and the first filter portion are integrally formed of the continuous piece of material such that the sump is a single unitary component;
a fluid circulation assembly for circulating fluid within the tub, the fluid circulation assembly including at least two spray assemblies for directing fluid onto articles placed in the wash chamber; and
a pump in fluid communication with the fluid circulation assembly, the pump having a pump inlet,
wherein the first filter portion of the sump is upstream of and in fluid communication with the pump inlet such that the pump inlet receives fluid filtered through the first filter element.

2. The dishwasher appliance of claim 1, wherein the sump further comprises a second filter portion integrally formed of the continuous piece of material such that the sump is a single unitary component comprising the sump portion, the first filter portion, and the second filter portion.

3. The dishwasher appliance of claim 1, wherein the sump further comprises a second filter portion, the second filter portion being removable from the sump.

4. The dishwasher appliance of claim 1, wherein the sump further comprises a second filter portion, and wherein the first filter portion is configured for removing different sized particulates than the second filter portion.

5. The dishwasher appliance of claim 1, wherein the sump further comprises a second filter portion, the second filter portion having a body that is generally cylindrical in shape.

6. The dishwasher appliance of claim 1, wherein in the sump further comprises a diverter for selectively diverting fluid flow from the pump to the spray assemblies, the diverter having a diverter housing integrally formed of the continuous piece of material such that the sump is a single unitary component comprising the sump portion, the first filter portion, and the diverter housing.

7. The dishwasher appliance of claim 6, wherein the diverter housing defines at least two outlet ports, each outlet port in fluid communication with a spray assembly.

8. A dishwasher appliance, comprising:
a tub defining a wash chamber;
a fluid circulation assembly for circulating fluid within the tub, the fluid circulation assembly including at least two spray assemblies for directing fluid onto articles placed in the wash chamber;
a pump in fluid communication with the fluid circulation assembly, the pump having a pump outlet;
a sump positioned in a bottom portion of the tub, the sump including a sump portion and a diverter for selectively diverting fluid flow from the pump to the spray assemblies, the diverter comprising
a diverter housing defining an inlet and at least two outlet ports, and
a diverter element movable within the diverter housing, the diverter element configured to divert fluid from the inlet to one of the at least two outlet ports,
wherein the sump portion and the diverter housing are formed of a continuous piece of material such that the sump is a single unitary component.

9. The dishwasher appliance of claim 8, wherein the inlet of the diverter housing is in fluid communication with the pump outlet.

10. The dishwasher appliance of claim 8, wherein the at least two outlet ports defined by the diverter housing are a first outlet port and a second outlet port,
wherein the diverter housing is a passive ball valve and the diverter element is a ball movable within the diverter housing between a first position and a second position, and
wherein in the first position the ball seals off the second outlet port such that the fluid flow is diverted through the first outlet port and in the second position the ball seals off the first outlet port such that the fluid flow is diverted through the second outlet port.

11. The dishwasher appliance of claim 10, wherein the diverter housing defines a looped path within which the ball is positioned, the looped path extending between the first outlet port and the second outlet port.

12. The dishwasher appliance of claim 8, wherein the diverter element is a disk positioned within the diverter housing and rotatable about an axis, the disk defining an aperture for selectively diverting the fluid flow through one of the at least two outlet ports.

13. The dishwasher appliance of claim 12, wherein a shaft extending along the axis connects the disk to a motor for rotating the disk.

14. The dishwasher appliance of claim 8, wherein the sump and diverter housing are formed of a single continuous piece of plastic.

15. A method for forming a unitary sump of a dishwasher appliance, comprising:
establishing three-dimensional information of the unitary sump;
converting the three-dimensional information of the unitary sump from the established three-dimensional information into a plurality of slices, each slice of the plurality of slices defining a respective cross-sectional layer of the unitary sump; and
successively forming each cross-sectional layer of the unitary sump with an additive process;
wherein, after each cross-sectional layer is successively formed, the unitary sump is formed such that the unitary sump includes a diverter housing portion integrally formed with a sump portion of a continuous piece of material, the diverter housing portion configured to receive fluid flow from a pump to be selectively diverted to a fluid circulation assembly by a diverter element positioned within the diverter housing portion.

16. The method of claim 15, wherein the additive process comprises at least one of fused deposition modeling, selective laser sintering, stereolithography, and digital light processing.

17. The method of claim 15, wherein, after each cross-sectional layer is successively formed, the unitary sump is further comprises a first filter portion integrally formed with the sump portion and the diverter housing portion of the continuous piece of material.

18. The method of claim 17, wherein, after each cross-sectional layer is successively formed, the unitary sump further comprises a second filter portion integrally formed with the sump portion, the diverter housing portion, and the first filter portion of the continuous piece of material.

19. The method of claim 15, wherein, after each cross-sectional layer is successively formed, the diverter housing portion defines a first outlet port and a second outlet port,
wherein the diverter housing portion is a passive ball valve and the diverter element positioned within the diverter housing portion is a ball movable within the diverter housing portion between a first position and a second position, and
wherein in the first position the ball seals off the second outlet port such that fluid flow into the diverter housing portion is diverted through the first outlet port and in the second position the ball seals off the first outlet port such that the fluid flow is diverted through the second outlet port.

20. The method of claim 15, wherein, after each cross-sectional layer is successively formed, the diverter housing portion defines a plurality of outlet ports, and wherein the diverter element positioned within the diverter housing portion is a disk rotatable about an axis, the disk defining an aperture for selectively diverting the fluid flow through one of the plurality of outlet ports.
